(19) United States
(12) Patent Application Publication
(10) Pub. No.: US 2025/0004786 A1
(43) Pub. Date: Jan. 2, 2025

(54) INTELLIGENT DRIVER CONFIGURABILITY

(71) Applicant: ATI Technologies ULC, Markham (CA)

(72) Inventors: Neil Cooper, Markham (CA); Koryun Muradyan, Markham (CA)

(21) Appl. No.: 18/346,053

(22) Filed: Jun. 30, 2023

(51) Int. Cl. G06F 9/4401

(52) U.S. Cl. CPC G06F 9/4411

(57) ABSTRACT

An apparatus and method for efficiently providing stability when updated graphics drivers are used in different hardware configurations. A client device includes one or more processors or another type of an integrated circuit that receives a given graphics driver package. When executed by the client device, the operating system stores the components of the authenticated graphics driver package in a protected system folder as part of a staging step. When the client device executes an application, the client device selects between a user mode driver (UMD) of the given graphics driver package and UMDs of the previously staged graphics driver packages. This selection is based on history information collected during past execution of the application. The client device executes the application using installations of the selected UMD and the kernel mode driver (KMD) of the given graphics driver package.

### BACKGROUND

### Description of the Relevant Art

Video graphics applications rely on graphics drivers for support. A graphics driver translates function calls in a video graphics application to commands particular to a piece of hardware such as a highly parallel data processor. With frequent releases of new applications and updated versions of preexisting applications, stability of these applications executed in particular computing environments is not always guaranteed. For example, users have a variety of computing environments with a large number of combinations of hardware and software configurations. Prior to a release making a particular updated version of a graphics driver available to users, testing the updated version of the graphics driver in the large number of combinations of hardware and software configurations while also meeting a short time-to-market metric is not possible many times.

In view of the above, efficient methods and apparatuses for providing stability when updated graphics drivers are used in different hardware configurations are desired.

### BRIEF DESCRIPTION OF THE DRAWINGS

FIG. 1 is a generalized diagram of apparatus that provides stability when updated graphics drivers are used in different hardware configurations.

FIG. 2 is a generalized diagram of computing system layering model that provides stability when updated graphics drivers are used in different hardware configurations.

FIG. 3 is a generalized diagram of driver selector that provides stability when updated graphics drivers are used in different hardware configurations.

FIG. 4 is a generalized diagram of computing system that provides stability when updated graphics drivers are used in different hardware configurations.

FIG. 5 is a generalized diagram of a method that provides stability when updated graphics drivers are used in different hardware configurations.

FIG. 6 is a generalized diagram of a method that provides stability when updated graphics drivers are used in different hardware configurations.

FIG. 7 is a generalized diagram of a method that provides stability when updated graphics drivers are used in different hardware configurations.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods that provide stability for updated graphics drivers used in different hardware configurations are contemplated. In various implementations, a client device includes hardware, such as circuitry, of one or more processors or another type of an integrated circuit that includes circuitry for receiving a given graphics driver package. For example, a user requests the given graphics driver package, and the client device receives a copy of the given graphics driver package that is downloaded from a network such as the Internet. In an implementation, the client device receives the downloaded copy of the given graphics driver package, and when executed by the circuitry of the client device, the operating system authenticates the graphics driver package. After successful authentication, the operating system stores the components of the graphics driver package in a protected system folder. The process of copying the graphics driver package to the protected system folder after authentication is called “staging.”

The graphics driver package includes multiple components such as at least two driver files, an installation file, a catalog file, and device files. The two driver files of the graphics driver package include dynamic link libraries (DLL) files of a user mode driver (UMD) and a kernel mode driver (KMD). The installation file (.inf file) includes information such as the name of the graphics driver package, a version of the graphics driver package, and registry information. The catalog file includes cryptographic hash values of one or more files in the graphics driver package. These hash values are used by the operating system to verify that the graphics driver package was not altered after the graphics driver package was published (created). The device files include one or more of a device installation application, a device icon, and device properties. As used herein, a “graphics driver package” is also referred to as a “graphics driver” or a “driver.”

The client device stores copies of one or more user mode drivers (UMDs) of the previously staged graphics driver packages to other protected holding locations in memory. These other protected holding locations in memory are different from the protected system folder. The client device performs this additional data storage step to maintain protected copies of these previously staged user mode drivers (UMDs), since the operating system removes the original copies of the previously staged UMDs when a duration of non-use exceeds a threshold. It is noted that it is possible that one or more of the staged UMDs have not been installed due to not being selected for use by the client device.

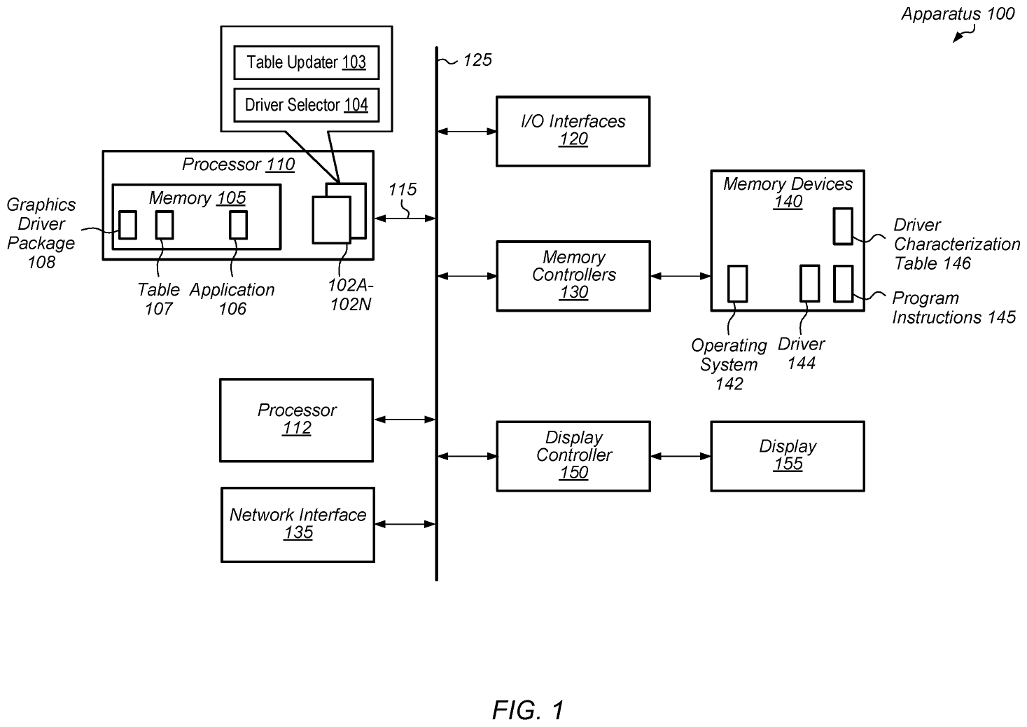

When the client device executes a process of an application, the client device selects between a UMD of the given graphics driver package and UMDs of the previously staged graphics driver packages. The client device performs this selection based at least in part on an identifier of the application, a version of the application, a version of the UMD, and one or more features selected by the user corresponding to execution of the application. The client device executes the process using installations of the selected UMD and the kernel mode driver (KMD) of the given graphics driver package. Further details of these techniques for efficiently providing stability when updated graphics drivers are used in different hardware configurations are provided in the following description of FIGS. 1-7.

Referring now to FIG. 1, a generalized diagram is shown of one implementation of an apparatus 100 that provides stability when updated graphics drivers are used in different hardware configurations. In an implementation, apparatus 100 includes at least processors 110-112, input/output (I/O) interfaces 120, bus 125, memory controllers 130, network interface 135, memory devices 140, display controller 150, and display 155. Processors 110-112 are representative of any number of processors which are included in apparatus 100. In other implementations, apparatus 100 includes other components and/or apparatus 100 is arranged differently. For example, phased locked loops (PLLs) or other clock generating circuitry are not shown for ease of illustration. In various implementations, the components of the apparatus 100 are on a same die such as a system-on-a-chip (SOC). In other implementations, the components are individual dies in a system-in-package (SiP) or a multi-chip module (MCM). A variety of computing devices use the apparatus 100 such as a desktop computer, a laptop computer, a server computer, a tablet computer, a smartphone, a gaming device, a smartwatch, and so on.

In one implementation, processor 110 is a general-purpose processor, such as a central processing unit (CPU), with any number of processor cores 102A-102N that include circuitry for executing program instructions. Memory 105 represents a local hierarchical cache memory subsystem. Memory 105 stores at least source data, intermediate results data, results data, and copies of data and instructions stored in memory devices 140. Processor 110 is coupled to bus 125 via interface 115. Processor 110 receives, via interface 115, copies of various data and instructions, such as shader programs, the operating system 142, the driver 144, program instructions 145, the driver characterization table 146, and/or other data and instructions. For example, the application 106 and the graphics driver package 108 stored in the memory 105 are copies of instructions stored in the memory devices 140. The driver characterization table 107 (or table 107) is a copy of the driver characterization table 146. However, the table 107 stores updated information as one of the processor cores 102A-102N performs the updates.

In some implementations, processor 110 executes the graphics driver package 108 for communicating with and/or controlling the operation of one or more of the other processors in apparatus 100. It is noted that depending on the implementation, the graphics driver package 108 can be implemented using any suitable combination of hardware, software, and/or firmware. In one implementation, processor 112 is a parallel data processor with a highly parallel data microarchitecture, such as a graphics processing unit (GPU) which renders pixels for display controller 150 to drive to display 155. A GPU is a complex integrated circuit that performs graphics-processing tasks. For example, a GPU executes graphics-processing tasks required by an end-user application, such as a video-game application.

GPUs are also increasingly being used to perform other tasks which are unrelated to graphics. The GPU can be a discrete device, such as a dedicated GPU (dGPU), or the GPU can be integrated (an iGPU) in the same package as another processor, such as a CPU. Other parallel data processors that can be included in apparatus 100 include digital signal processors (DSPs), field programmable gate arrays (FPGAs), application specific integrated circuits (ASICs), and so forth. In some implementations, processors 110-112 include multiple parallel data processors.

In some implementations, apparatus 100 utilizes a communication fabric (“fabric”), rather than the bus 125, for transferring requests, responses, and messages between the processors 110-112, the I/O interfaces 120, the memory controllers 130, the network interface 135, and the display controller 150. When messages include requests for obtaining targeted data, the circuitry of interfaces within the components of apparatus 100 translates target addresses of requested data. In some implementations, the bus 125, or a fabric, includes circuitry for supporting communication, data transmission, network protocols, address formats, interface signals and synchronous/asynchronous clock domain usage for routing data.

Memory controllers 130 are representative of any number and type of memory controllers accessible by processors 110-112. While memory controllers 130 are shown as being separate from processors 110-112, it should be understood that this merely represents one possible implementation. In other implementations, one of memory controllers 130 is embedded within one or more of processors 110-112 or it is located on the same semiconductor die as one or more of processors 110-112. Memory controllers 130 are coupled to any number and type of memory devices 140.

Memory devices 140 are representative of any number and type of memory devices. For example, the type of memory in memory devices 140 includes Dynamic Random Access Memory (DRAM), Static Random Access Memory (SRAM), NAND Flash memory, NOR flash memory, Ferroelectric Random Access Memory (FeRAM), or otherwise. Memory devices 140 store at least instructions of an operating system 142, the driver 144, and program instructions 145, which can include a first set of program instructions of an application such as a video graphics application. Copies of these instructions can be stored in a memory or cache device local to processor 110 and/or processor 112.

I/O interfaces 120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices (not shown) are coupled to I/O interfaces 120. Such peripheral devices include (but are not limited to) displays, keyboards, mice, printers, scanners, joysticks or other types of game controllers, media recording devices, external storage devices, and so forth. Network interface 135 is able to receive and send network messages across a network.

In various implementations, the driver 144 is a video graphics driver downloaded from a network, such as the Internet, via the network interface 135. The driver 144 is a graphics driver package that includes separate components. The separate components include at least two driver files, an installation file, a catalog file, and device files. The two driver files of the graphics driver package include dynamic link libraries (DLL) files of a user mode driver (UMD) and a kernel mode driver (KMD). The installation file (.inf file) includes information such as a name of the graphics driver package, a version of the graphics driver package, and registry information. The catalog file includes cryptographic hash values of one or more files in the graphics driver package. These hash values are used by the operating system to verify that the graphics driver package was not altered after the graphics driver package was published (created). The device files include one or more of a device installation application, a device icon, and device properties.

When executed by the circuitry of the processor 110, the operating system authenticates the graphics driver package. After successful authentication, the operating system stores the components of the graphics driver package in a protected system folder. In an implementation, the operating system is a version of the Microsoft® Windows® operating system, and the protected system folder in such a system is called the “Driver Store.” The process of copying the graphics driver package to the protected system folder after authentication is called “staging.” In some implementations, the processor 110 stores a copy of one or more user mode drivers of previously staged graphics driver packages in protected holding locations in the memory devices 140. Otherwise, these copies can be lost, since while executing the operating system, the processor 110 removes the original copies of the previously staged graphics driver packages when a duration of non-use exceeds a threshold.

After a copy of the driver 144 (graphics driver package) is stored in the memory devices 140, the circuitry of the driver selector 104 of the processor 110 determines which version of the UMD to use for a particular application such as application 106. In various implementations, the circuitry of the table updater 103 and the driver selector 104 includes circuitry of the processor 110 that executes the instructions of the KMD of the graphics driver package. In some implementations, the driver selector 104 uses the driver characterization table 107 (or table 107), which stores an updated copy of the information stored in the driver characterization table 146 (or table 146). For a particular version of a particular application, such as application 106, and a particular version of a UMD, the table 107 stores characteristics based on previous executions of the application 106 using the particular version of the UMD. Examples of these characteristics are a number of launches of the application 106, a number of crashes of the application 106, a number of timeout detection and recovery (TDR) events of the application 106, and so forth.

If the table 107 stores information indicating that a UMD of a previously staged graphics driver package indicates good execution results for the application 106, then the driver selector 104 selects this UMD. A younger UMD from a most-recently staged graphics driver package can be available, but the driver selector 104 does not select the younger UMD based on the information stored in the table 107. Therefore, when the processor 110 executes the application 106, the processor 110 uses the graphics driver package 108, which includes the UMD of the previously staged graphics driver package that is older than the most-recently staged graphics driver package. The graphics driver package 108 also includes the KMD of the most-recently staged graphics driver package. Therefore, the processor 110 executes the process of the application using installations of the selected UMD (from a previously staged graphics driver package) and the kernel mode driver (KMD) of the most-recently staged graphics driver package. During execution of the application 106, the circuitry of the table updater 103 updates the information stored in the table 107.

In various implementations, the UMD of the most-recently staged graphics driver package includes function declarations of one or more exported functions of a dynamic link library (DLL) that defines the functionality of the exported functions. In an implementation, the UMD of the most-recently staged graphics driver package includes no defined functionality, but only identifies function declarations of one or more exported functions in the DLL. In such an implementation, this UMD of the most-recently staged graphics driver package includes a function call to load a particular library such as a particular DLL. In an implementation, this UMD includes a call such as the LoadLibrary A function of the Microsoft Windows operating system. When the driver selector 104 selects between a UMD of the most-recently staged graphics driver package and UMDs of the previously staged graphics driver packages, the driver selector 104 selects which version of the identified DLL to use from the other protected holding locations in memory different from the protected system folder.

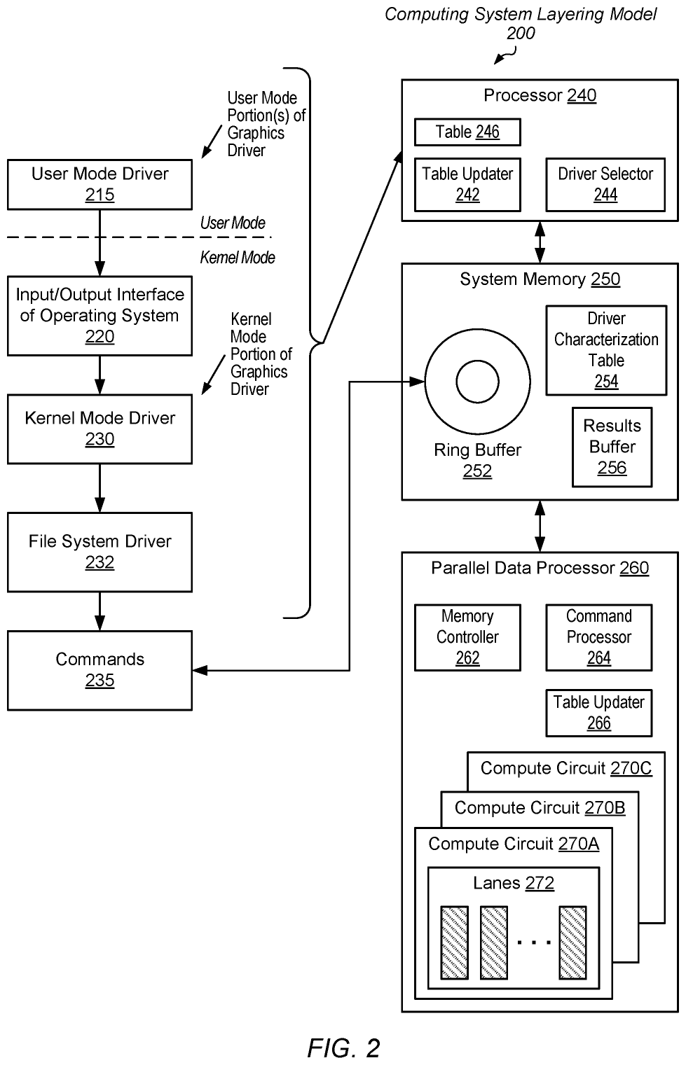

When the processor 110 executes another application or another version of the application 106 that does not have history information stored in the table 107 (and table 146), the driver selector 104 selects the UMD of the most-recently staged graphics driver package. Similarly, if history information exists in the table 107 (and table 146), but the history information corresponding to a UMD of a previously staged graphics driver package indicates poor execution results for the application 106, then the driver selector 104 selects the UMD of the most-recently staged graphics driver package. In the below discussion of FIGS. 2-7, further details are provided of selecting a UMD in order to provide stability for updated graphics drivers used in different hardware configurations.

Turning now to FIG. 2, a generalized diagram is shown of an implementation of a computing system layering model 200 that provides stability when updated graphics drivers are used in different hardware configurations. As shown, the computing system layering model 200 (or layering model 200) uses a collection of user mode components, kernel mode components, and hardware. The layering model 200 includes hardware, such as circuitry, of the processor 240 and the parallel data processor 260 using system memory 250 between them. The software components 215-235 are executed by the circuitry of the processor 240. The commands 235 are stored in the ring buffer 252 of the system memory 250. These commands are executed by the circuitry of the parallel data processor 260. In the layering model 200, each driver is responsible for processing a part of a request. If the request cannot be completed, information for the lower driver in the stack is set up and the request is passed along to that driver. Functionality is dynamically added to a driver stack. It also allows each driver to specialize in a particular type of function and decouples it from having to know about other drivers.

In some implementations, the processor 240 is a general-purpose processor such as a CPU, and the parallel data processor 260 is a GPU. Threads are scheduled on one of the processor 240 and the parallel data processor 260 in a manner that each thread has the highest instruction throughput based at least in part on the runtime hardware resources of the processor 240 and the parallel data processor 260. Threads that are associated with general-purpose algorithms are scheduled on the processor 240, while other threads that are associated with parallel data computationally intensive algorithms such as video graphics rendering algorithms are scheduled on the parallel data processor 260.

To change the scheduling of threads from the processor 240 to the parallel data processor 260, software development kits (SDKs) and application programming interfaces (APIs) were developed for use with widely available high-level languages to provide supported function calls. The function calls provide an abstraction layer of the parallel implementation details of the parallel data processor 260. The details are hardware specific to the parallel data processor 260 but hidden to the developer to allow for more flexible writing of software applications. The function calls in high level languages, such as C, C++, FORTRAN, and Java and so on, are translated to commands which are later processed by the hardware in the parallel data processor 260.

The multiple, parallel computational lanes 272 of the multiple compute circuits 270A-270C can be used for real-time data processing such as rendering multiple pixels, image blending, pixel shading, vertex shading, and geometry shading. The compute circuits 270A-270C can also be used to execute other threads that require operating simultaneously with a relatively high number of different data elements (or data items). Examples of these threads are threads for scientific, medical, finance and encryption/decryption computations. Applications, such as video graphics applications, are written by a developer in one of a variety of high-level programming languages such as such as C, C++, FORTRAN, Java and so on. The applications begin processing on a general-purpose processor such as a CPU. In various implementations, the processor 240 begins processing the applications. A graphics library uses the user mode driver (UMD) 215 to translate function calls in an application to commands particular to a piece of hardware, such as a GPU, and send the translated commands to the kernel mode driver (KMD) 230 via the input/output (I/O) interface 220 of the operation system. In one implementation, an I/O control system call interface is used. In some implementations, the parallel data processor 260 is the GPU.

The video graphics application in the chosen higher-level language is partially processed with the aid of graphic libraries with their own application program interfaces (APIs). Platforms such as OpenCL (Open Computing Language), OpenGL (Open Graphics Library), OpenGL for Embedded Systems (OpenGL ES), and Vulkan provide a variety of APIs for running programs on GPUs from AMD, Inc. Developers use OpenCL for simultaneously processing the multiple data elements of the scientific, medical, finance, encryption/decryption and other computations while using OpenGL and OpenGL ES for simultaneously rendering multiple pixels for video graphics computations. Vulkan is a low-overhead, cross-platform API, open standard for three-dimensional (3-D or 3D) graphics applications. Further, DirectX is a platform for running programs on GPUs in systems using one of a variety of Microsoft operating systems.

In various implementations, the kernel mode driver 230 redirects I/O requests to the driver managing the target device object such as file system driver 232 for the memory. The file system driver 232 provides a means for a video graphics application to send information, such as the translated commands 235, to storage media such as the ring buffer 252 of system memory 250. These requests are dispatched to the file system driver 232 via the I/O interface 220 or the kernel mode driver 230. In some implementations, while executing the user mode driver 215, the processor 240 ensures only one process sends translated commands to the hardware of another processor, such as the parallel data processor 260, at a time by using locking primitives.

In some implementations, while executing the user mode driver 215, the processor 240 sends command groups to the kernel mode driver 230. The command groups are a set of commands to be sent and processed atomically. While executing the kernel mode driver 230, the processor 240 assigns state information for a command group. Examples of the state information are a process identifier (ID), a name of the application or an ID of the application, a version of the application, a compute/graphics type of work, and so on. The kernel mode driver 230 sends the command group and state information to the ring buffer 122 in the hardware layer via the file system driver 232. The command processor 264 of the parallel data processor 260 accesses, via the memory controller 262, the command group and state information stored in the ring buffer 252. The command processor 264 schedules the retrieved commands to the compute circuits 270A, 270B and 270C based on at least the state information. Other examples of scheduling information used to schedule the retrieved commands are age of the commands, priority levels of the commands, an indication of real-time data processing of the commands, and so forth.

In various implementations, each of the compute circuits 270B and 270C includes similar circuitry and components as the compute circuit 270A. Although three compute circuits 270A-270C are shown, in other implementations, another number of compute circuits are used. In some implementations, the parallel computational lanes 272 (or lanes 272) operate in lockstep. In various implementations, the data flow within each of the lanes 272 is pipelined. Pipeline registers are used for storing intermediate results and circuitry for arithmetic logic units (ALUs) perform integer arithmetic, floating-point arithmetic, Boolean logic operations, branch condition comparisons and so forth. These components are not shown for ease of illustration. Each of the ALUs within a given row across the lanes 272 includes the same circuitry and functionality, and operates on a same instruction, but different data associated with a different thread. A particular combination of the same instruction and a particular data item of multiple data items is referred to as a “work item.” A work item is also referred to as a thread. Each data item is processed independently of other data items, but the same sequence of operations of the subroutine is used. Multiple work items are grouped into a wave front for simultaneous execution by the multiple lanes 272 of the compute circuits 270A-270C.

Although an example of a single instruction multiple data (SIMD) micro-architecture is shown for the compute circuits 270A-270C, other types of highly parallel data micro-architectures are possible and contemplated. The high parallelism offered by the hardware of the compute circuits 270A-270C is used for real-time data processing. Examples of the real-time data processing are rendering multiple pixels, image blending, pixel shading, vertex shading, and geometry shading. In such cases, each of the data items of a wave front is a pixel of an image. The parallel data processor 260 stores results data in the results buffer 256 of the system memory 250. It is noted, for ease of illustration, that multiple hardware components are not shown such as power management circuitry, interrupt controllers, phased locked loops (PLLs) or other clock generating circuitry, one or more levels of a cache memory subsystem, a video decoder, a display controller, a local data store within the compute circuits 270A-270C, local cache memories within the compute circuits 270A-270C, and so forth.

In various implementations, a copy of a graphics driver package is downloaded from a network and stored on the system memory 250. The graphics driver package includes separate components such as at least a user mode driver (UMD) and a kernel mode driver (KMD). After the copy of the graphics driver package is stored in the system memory 250, the circuitry of the driver selector 244 of the processor 240 determines which version of the UMD to use for a particular application such as a video graphics application. In various implementations, the driver selector 244 has the same functionality as the driver selector 104 (of FIG. 1). In these implementations, the circuitry of the table updater 242 and the driver selector 244 includes circuitry of the processor 240 that executes the instructions of the KMD of the graphics driver package. The driver selector 244 uses the driver characterization table 246 (or table 246), which stores an updated copy of the information stored in the driver characterization table 254 (or table 254) of the system memory 250. For a particular version of a particular application, and a particular version of a UMD, the table 246 (and table 254) stores characteristics based on previous executions of the application using the particular version of the UMD. Examples of these characteristics are a number of launches of the application, a number of crashes of the application, a number of timeout detection and recovery (TDR) events of the application, and so forth.

In addition to the version of the application, and the version of the UMD, in some implementations, the table 246 (and table 254) stores characteristics based further on features selected by a user for the application. Examples of the features are anti-aliasing is enabled, a level of the enabled anti-aliasing, vertical synchronization, and power management settings. If the table 246 stores information indicating that a UMD of a previously staged graphics driver package indicates good execution results for the application, then the driver selector 244 selects this UMD. A younger UMD from a most-recently staged graphics driver package can be available, but the driver selector 244 does not select the younger UMD based on the information stored in the table 246. Therefore, when the processor 240 executes the application, the processor 240 uses the UMD of the previously staged graphics driver package that is older than the most-recently staged graphics driver package. The processor 240 also uses the KMD of the most-recently staged graphics driver package, which is the KMD 230.

During execution of the application, the circuitry of the table updater 242 updates the information stored in the table 246. In addition, the circuitry of the table updater 266 of the parallel data processor 260 is able to update the information stored in the table 246. In some implementations, the table updater 266 stores updates in the system memory 250 and later notifies the processor 240 of the table updates. This producer-consumer relationship regarding the table updates is similar to transferring the results data in the results buffer 256 from the parallel data processor 260 to the processor 240.

When the processor 240 and the parallel data processor 260 execute another application or another version of the application that does not have history information stored in the table 246 (and table 254), the driver selector 244 selects the UMD of the most-recently staged graphics driver package. Similarly, if history information exists in the table 246 (and table 254), but the history information corresponding to a UMD of a previously staged graphics driver package indicates poor execution results for the application 106, then the driver selector 244 selects the UMD of the most-recently staged graphics driver package. In some implementations, the processor 240 stores a copy of one or more user mode drivers of previously staged graphics driver packages in protected holding locations in the system memory 250. Otherwise, these copies can be lost, since while executing the operating system, the processor 240 removes the original copies of the previously staged graphics driver packages when a duration of non-use exceeds a threshold.

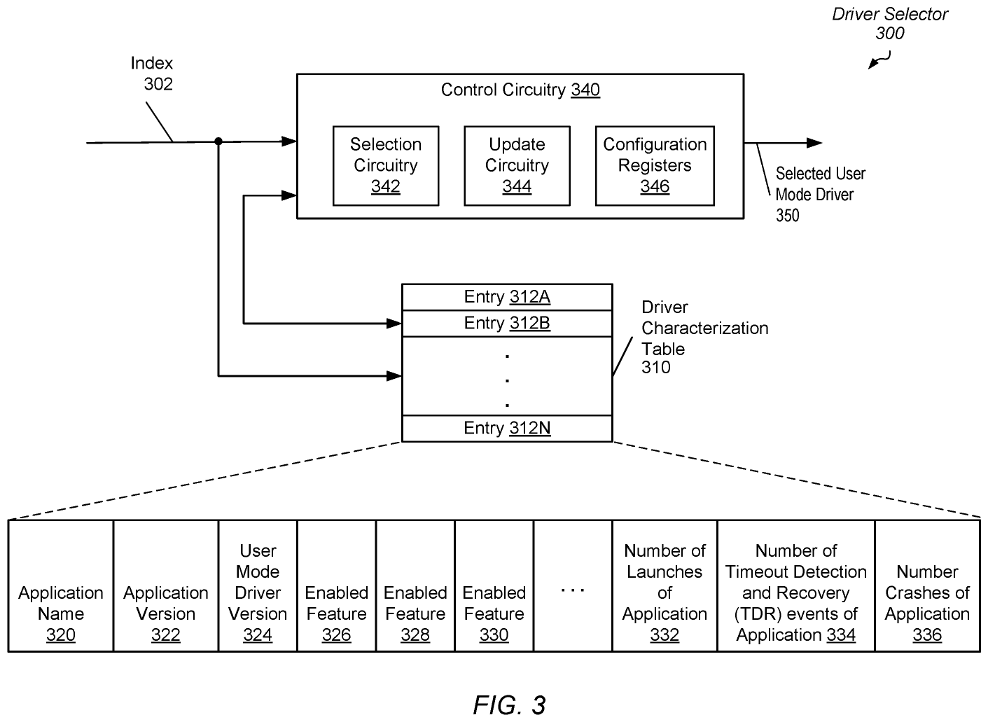

Turning now to FIG. 3, a generalized diagram is shown of a driver selector 300 that provides stability when updated graphics drivers are used in different hardware configurations. As shown, the driver selector 300 includes the driver characterization table 310 (or table 310) and the control circuitry 340. The control circuitry 340 receives an index 302 and information from the table 310 and generates either updates of the table 310 or an indication specifying the selected user mode driver 350. The control circuitry 340 includes the selection circuitry 342, the update circuitry 344, and the configuration registers 346. The table 310 stores information in the entries 312A-312N. Each of these entries includes the fields 320-336. In various implementations, the functionality provided by the driver selector 300 is also provided in the driver selector 104 (of FIG. 1) and the driver selector 244 (of FIG. 2).

The table 310 is implemented with one of flip-flop circuits, one of a variety of types of a random-access memory (RAM), a content addressable memory (CAM), or other. Although particular information is shown as being stored in the fields 320-336, and in a particular contiguous order, in other implementations, a different order is used and a different number and type of information is stored. The table 310 includes information that characterizes the execution of a particular version of a particular application and a particular version of a user mode driver (UMD). The field 320 stores a unique identifier (ID) or name of an application. The field 322 stores an indication, such as a number, of a version of this application.

The field 324 stores an indication, such as a number, of a version of a UMD that is used during the execution of the version of the application identified in the fields 320 and 322. Each of the fields 326, 328 and 330 stores an indication of a feature enabled by a user. Examples of the features are anti-aliasing is enabled, a level of the enabled anti-aliasing, vertical synchronization, and power management settings. Anti-aliasing is a video game application feature or setting that allows images to appear less blurred due to smoothing out of the edges of the images. Vertical synchronization, or vertical sync (or vsync), is a graphics feature that synchronizes the frame rate of a video game with a refresh rate of a display device such as a monitor of a video gaming system. A power management setting allows one or more power saving features to be enabled that dynamically regulates the frame rate based on a character controlled by the user and camera movements within the video game. In other implementations, another number and types of features are selected (or enabled) by the user and stored in the table 310.

The fields 332-336 store statistics of events that occur during the execution of the during the execution of the version of the application identified in the fields 320 and 322. The execution is also based on the UMD identified in field 324 and the features identified in fields 326-330. The field 332 stores a number (or count) of launches of the application during execution. The field 324 stores a number (or count) of timeout detection and recovery (TDR) events of the application during execution. The field 336 stores a number (or count) of crashes of the application during execution. In other implementations, another number and types of events based on execution of the application are stored in the table 310.

The processor (circuitry external from the driver selector 300) generates the index 302 based at least in part on an identifier of the application, a version of the application, a version of the UMD, and one or more features selected by the user corresponding to execution of the application. In some implementations, the processor concatenates this information. In other implementations, the processor performs a hash function or uses another algorithm using this information as input values to generate the index 302. Although not shown, in some implementations, the entries 312A-312N of the table 310 include a field that stores the index 302. Additionally, the entries 312A-312N include a field that stores status information such as at least a valid bit, age information, and so forth.

The selection circuitry 342 receives an indication of a hit or a miss as a result of the search of the table 310 using the index 302. If a miss occurs, then the selection circuitry 342 selects a user mode driver from a most-recently staged graphics driver package as the selected user mode driver 350. In addition, the control circuitry 340 allocates an available entry of the entries 312A-312N and fills the fields 320-330 with information corresponding to the application and the selected user mode driver. As the application executes, the update circuitry 344 fills the fields 332-336 based on events that occur as the application executes.

If a hit occurs, then the selection circuitry 342 reads one or more of the fields 332-336 of the hit entry and compares the information with corresponding thresholds stored in the configuration registers 346. The values stored in the configuration registers 346 can be read from flip-flop circuits, one of a variety of types of a ROM, one of a variety of types of a random-access memory (RAM), a content addressable memory (CAM), or others. In various implementations, the configuration registers 346 include programmable registers. If some implementations, the selection circuitry 342 generates a weighted sum based on the comparisons and compares the weighted sum to a corresponding threshold. The comparisons are used to determine whether the version of the user mode driver stored in field 324 of the hit table entry should be used for a subsequent execution of the particular version of the application. If so, then the selection circuitry 342 sends this version of the user mode driver as the selected user mode driver 350. If not, then the selection circuitry 342 selects a user mode driver from a most-recently staged graphics driver package as the selected user mode driver 350.

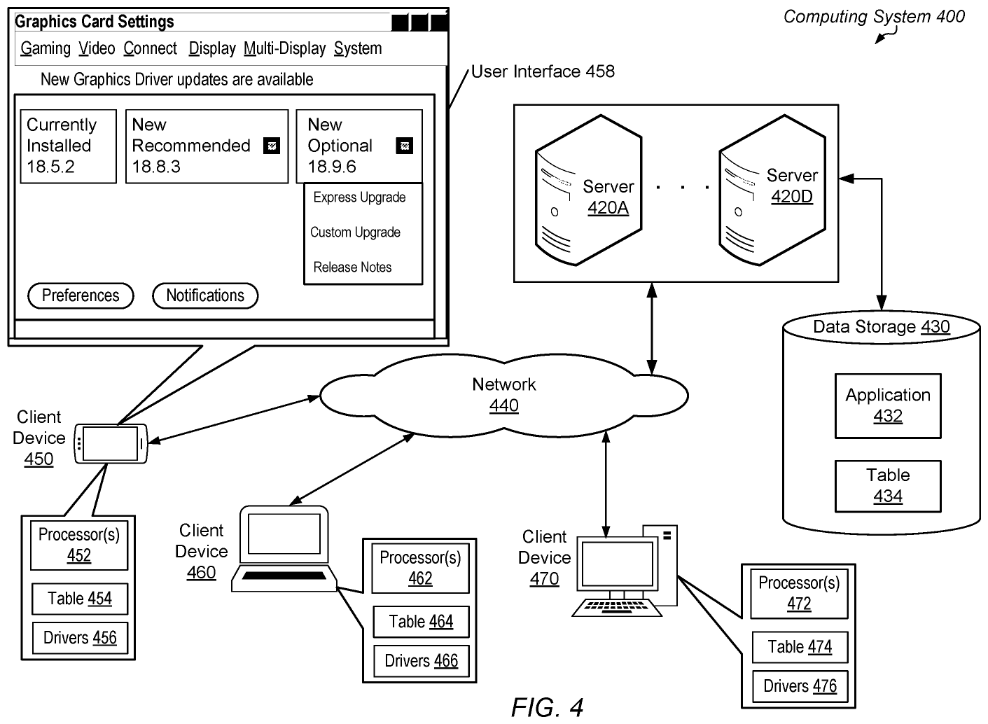

Turning now to FIG. 4, a generalized diagram is shown of a computing system 400. In the illustrated implementation, the computing system 400 includes multiple client devices 450, 460 and 470, a network 440, the servers 420A-420D, and the data storage 430 that includes a copy of an application 432. Although three client devices 450, 460 and 470 are shown, any number of client devices access applications stored on data storage 430 via the servers 420A-420D and the network 440. Examples of the client devices 450, 460 and 470 are a laptop computer, a smartphone, a gaming console connected to a television, a tablet computer, a desktop computer, or otherwise.

In various implementations, each of the client devices 450, 460 and 470 (or clients 450-470) includes hardware, such as circuitry, of one or more processors or another type of an integrated circuit that includes circuitry for receiving a given graphics driver package. As shown, the client device 450 includes the circuitry of one or more processors 452, a driver characterization table 454 (or table 454) stored in local memory, and one or more drivers 456 stored in local memory. The one or more drivers include at least video graphics drivers of downloaded graphics driver packages. The client devices 460 and 470 include similar components. However, the hardware configurations are different between one or more of the clients 450-470. In various implementations, the client devices 450, 460 and 470 include a network interface (not shown) supporting one or more communication protocols for data and message transfers through the network 440.

The network 440 includes multiple switches, routers, cables, wireless transmitters, and the Internet for transferring messages and data. Accordingly, the network interface of the client device 450 supports one or more of the Hypertext Transfer Protocol (HTTP), the Transmission Control Protocol (TCP), the User Datagram Protocol (UDP), or another protocol for communication across the World Wide Web. The servers 420A-420D include a variety of server types such as database servers, computing servers, application servers, file servers, mail servers and so on. In various implementations, the servers 420A-420D and the client devices 450, 460 and 470 operate with a client-server architectural model.

In some implementations, an organizational center (not shown) maintains the application 432. In addition to communicating with the client devices 450, 460 and 470 through the network 440, the organizational center also communicates with the data storage 430 for storing and retrieving data. The data storage 430 includes one or more of a variety of hard disk drives and solid-state drives for data storage. Through user authentication, users are able to access resources through the organizational center to update user profile information, access a history of purchases or other accessed content, and download content.

In some implementations, the server 420A stores a copy of the application 432 and provides this copy to a requesting device of the client devices 450-470 after a validation process successfully completes. The validation process can include verification of a login process in addition to verification of any payment. In another implementation, the server 420A supports a corresponding one of the client devices 450-470 accessing a streaming service, such as the application 432, and remotely requests executing the streaming service. An example of the streaming service is a video game streaming service. The streaming service provides real-time updates of video content based on inputs from the user as the user accesses the streaming service on the corresponding one of the client devices 450-470.

In an implementation, the application 432 includes instructions that support parallel data algorithms. In an implementation, the application 432 includes algorithms for a graphics shader program that directs how the processor renders pixels for controlling lighting and shading effects. In addition, the application 432 can also include pixel interpolation algorithms for geometric transformations. Pixel interpolation obtains new pixel values at arbitrary coordinates from existing data. The application 432 can also include instructions for directing a single-instruction-multiple-data (SIMD) core to perform General Matrix to Matrix Multiplication (GEMM) operations when rendering macroblocks of a video frame.

In various implementations, the processors 452, 462 and 472 have the same functionality described earlier for the processors 110 and 112 (of FIG. 1), the processor 240 and the parallel data processor 260 (of FIG. 2), and the driver selector 300 (of FIG. 3). For example, the processors 452, 462 and 472 have the same functionality as the table updater 103 and the driver selector 104 (of FIG. 1), and the table updater 242 and the driver selector 244 and the table updated 266 (of FIG. 2). Therefore, for client device 450, the circuitry of a table updater and a driver selector (not shown) includes circuitry of one of the processors 452 that executes the instructions of the KMD of the graphics driver package. Regarding client device 450, one of the processors 452 translates instructions of a parallel data function call of a copy of the application 432 to commands that are executable by another one of the processors 452. The client devices 460 and 470 can implement a table updated and a driver selector and execute application 432 in a similar manner as client device 450.

In some implementations, the application 432 (and any copies) is a user-requested application that is a particular video game application accessed through the network 440 that provides content in real time to a user operating one of the client devices 450-470. In other implementations, the application 432 is a user-requested application that provides a live stream of another user broadcasting content such as reviews of products. In yet other implementations, the application 432 is a user-requested application that provides playback of a movie. In each of these implementations, the server 420A provides rendered and compressed information of a video frame in real time to a corresponding one of the client devices 450-470, which decodes and provides the information in real time to a display device.

In other implementations, the server 420A provides a copy of the application 432 to a requesting one of the client devices 450-470, which performs rendering of the video frame in real time independent of the server 420A based on function calls of the application 432 and supported APIs. The requesting one of the client devices 450-470 then sends the rendered information to a corresponding display device. In any of these cases, the client devices 450-470 use particular components (UMD, KMD) of graphics drivers of the drivers 456, 466 and 476. The processors 452, 462 and 472 access a corresponding one of the tables 454, 464 and 474 to select particular components (UMD, KMD) of graphics drivers of the drivers 456, 466 and 476. In various implementations, the tables 454, 464 and 474 store information in a similar manner as tables 107 and 146 (of FIG. 1), tables 246 and 254 (of FIG. 2), and table 310 (of FIG. 3).

It is noted that even when each of the client devices 450-470 stores a local copy of the application 432, it is possible that one or more of the client devices 450-470 store a different version of the application 432 than other ones of the client devices 450-470. Additionally, it is possible that one or more of the client devices 450-470 has a different hardware configuration than other ones of the client devices 450-470. Therefore, a number of events occurring during execution of the application 432 can differ among the client devices 450-470. Examples of the events are crashes of the application 432 and timeout detection and recovery (TDR) events. Accordingly, it is possible that the tables 454, 464 and 474 store different information even for a copy of a same version of the application 432. Based on the different information in the tables 454, 464 and 474, the client devices 450-470 can select different version of a user mode driver to use with a kernel mode driver of a corresponding most-recently staged graphics driver package.

It is also noted that in some implementations, one or more of the client devices 450-470 execute program code for collecting and submitting telemetry data to a centralized location. The centralized location can be a site for the vendor that produced a particular application such as the application 432. The telemetry data can be submitted based on preset events or schedules. In various implementations, the telemetry data includes at least a copy of a corresponding table of the tables 454, 464 and 474. In addition, the telemetry data can include an indication of the hardware configuration of a corresponding one of the client devices 450-470 sending the telemetry data. The table 434 stores information collected from the telemetry data.

In an implementation, each of the client devices 450 and 460 with different hardware configurations executes one or more versions of the application 432 and maintains a corresponding one of the tables 454 and 464. Each of the client devices 450 and 460 also sends telemetry data to a centralized location that builds the table 434 based on the received telemetry data. At a later time, the client device 470 performs an initial request for the application 432. In addition to receiving a copy of the application 432, the client device 470 also receives at least a subset of the table 434 based on the hardware configuration of the client device 470. Therefore, the processors 472 already have history information stored in the table 474 to use for selecting a version of a user mode driver despite not yet ever executing the application 432.

It is noted that clock sources, such as phase lock loops (PLLs), interrupt controllers, a communication fabric, power controllers, memory controllers, interfaces for input/output (I/O) devices, and so forth are not shown in the computing system 400 for ease of illustration. It is also noted that the number of components of the computing system 400 and the number of subcomponents for those shown in FIG. 4, such as within the clients 450, 460 and 470, can vary from implementation to implementation. There can be more or fewer of each component/subcomponent than the number shown for the computing system 400.

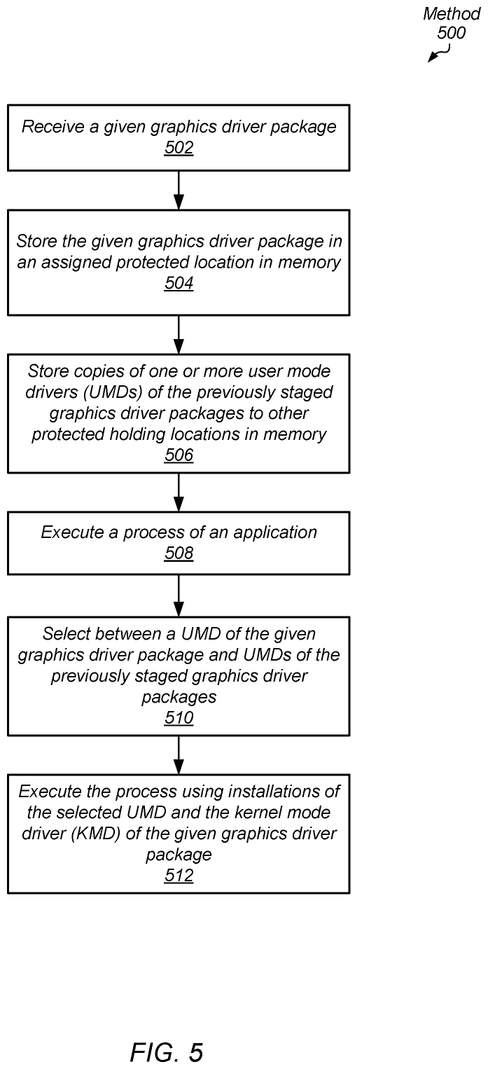

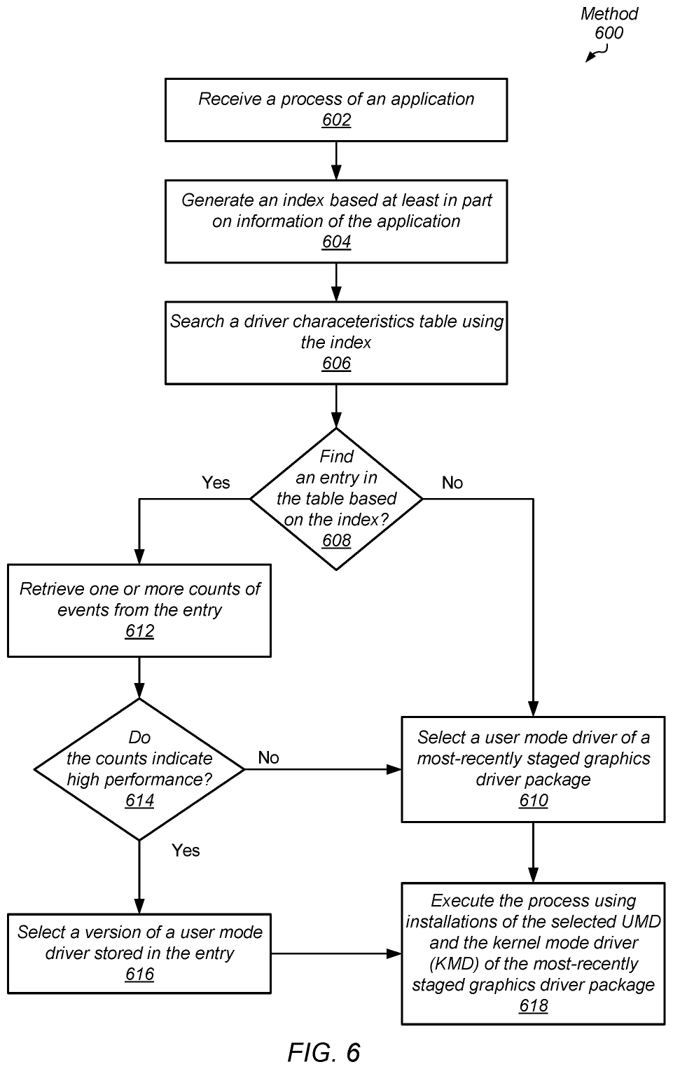

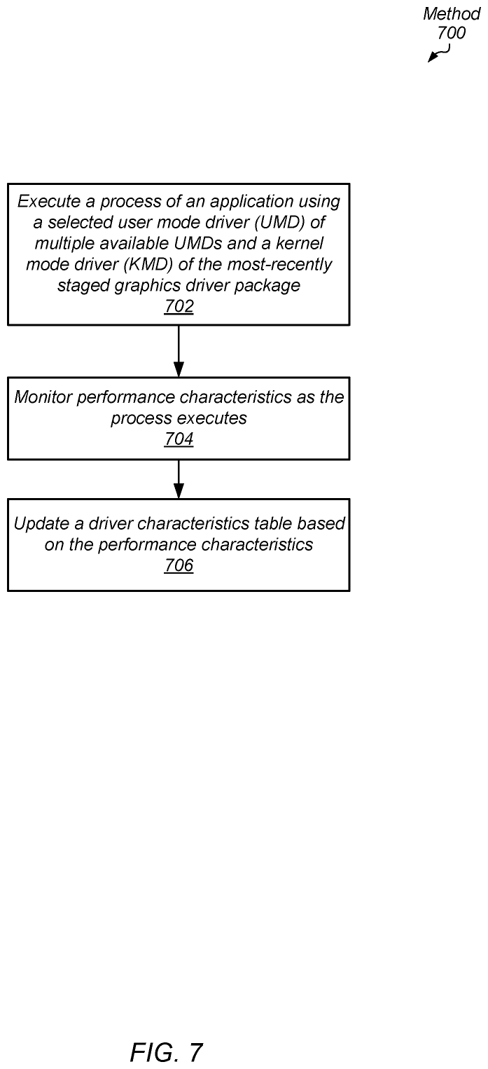

Referring to FIG. 5, a generalized diagram is shown of a method 500 that provides stability when updated graphics drivers are used in different hardware configurations. For purposes of discussion, the steps in this implementation (as well as in FIGS. 6-7) are shown in sequential order. However, in other implementations some steps occur in a different order than shown, some steps are performed concurrently, some steps are combined with other steps, and some steps are absent.

The circuitry of a client device includes one or more of a parallel data processor, another processor, or other circuitry. The client device receives a given graphics driver package (block 502). For example, a user requests the given graphics driver package, and the client device receives a copy of the given graphics driver package that is downloaded from a network such as the Internet. The client device stores the given graphics driver package in an assigned protected location in memory (block 504). In an implementation, the client device receives the downloaded copy of the given graphics driver package, and the operating system of the client device performs validation steps to authenticate the received graphics driver package. In some implementations, as part of an operating system staging step, the client device validates the given graphics driver package, and upon successful validation, the client device stores the given graphics driver package in the assigned protected location in memory. Further details of such an operating system staging step are provided in the below description.

The graphics driver package includes multiple components such as at least two driver files, an installation file, a catalog file, and device files. The two driver files of the graphics driver package include dynamic link libraries (DLL) files of a user mode driver (UMD) and a kernel mode driver (KMD). The installation file (.inf file) includes information such as a name of the graphics driver package, a version of the graphics driver package, and registry information. The catalog file includes cryptographic hash values of one or more files in the graphics driver package. These hash values are used by the operating system to verify that the graphics driver package was not altered after the graphics driver package was published (created). The device files include one or more of a device installation application, a device icon, and device properties.

After successful authentication, when executed by the circuitry of a general-purpose processor, the operating system stores the components of the graphics driver package in a protected system folder. The process of authenticating the received given graphics driver package and copying the graphics driver package to the protected system folder after successful authentication is called staging. The client device stores copies of one or more user mode drivers (UMDs) of the previously staged graphics driver packages to other protected holding locations in memory (block 506). These other protected holding locations in memory are different from the protected system folder. The client device performs this additional data storage step to maintain protected copies of these previously staged user mode drivers (UMDs), since the operating system removes the original copies of the previously staged UMDs from the protected system folder (such as Driver Store) when a duration of non-use exceeds a threshold. It is noted that it is possible that one or more of the staged UMDs have not been installed due to not being selected for use by the client device.

The client device executes a process of an application (block 508). In various implementations, the process corresponds to a function call that provides an abstraction layer of the parallel hardware implementation details of a parallel data processor. The client device selects between a UMD of the given graphics driver package and UMDs of the previously staged graphics driver packages (block 510). The client device performs this selection based at least in part on an identifier of the application, a version of the application, a version of the UMD, and one or more features selected by the user corresponding to execution of the application.

In some implementations, the client device maintains a table that tracks events during execution of one or more versions of the application and the UMDs. In some implementations, this table stores information in a similar manner as tables 107 and 146 (of FIG. 1), tables 246 and 254 (of FIG. 2), and table 310 (of FIG. 3). In an implementation, the circuitry of the client device has the same functionality described earlier for the processors 110 and 112 (of FIG. 1), the processor 240 and the parallel data processor 260 (of FIG. 2), and the driver selector 300 (of FIG. 3). The client device executes the process using installations of the selected UMD and the kernel mode driver (KMD) of the given graphics driver package (block 512). In various implementations, the UMD of the given graphics driver package includes function declarations of one or more exported functions of a dynamic link library (DLL) that defines the functionality of the exported functions. In an implementation, the UMD of the given graphics driver package includes no defined functionality, but only identifies function declarations of one or more exported functions in the DLL. In such an implementation, the UMD of the given graphics driver package includes a function call to load a particular library such as a particular DLL. In an implementation, this UMD includes a call such as the LoadLibraryA function of the Microsoft Windows operating system. In the earlier block 510, when the client device selects between a UMD of the given graphics driver package and UMDs of the previously staged graphics driver packages, the client device selects which version of the identified DLL to use from the other protected holding locations in memory different from the protected system folder.

Turning now to FIG. 6, a generalized diagram is shown of a method 600 that provides stability when updated graphics drivers are used in different hardware configurations. The circuitry of a client device includes one or more of a parallel data processor, another processor, or other circuitry. The circuitry of the client device receives a process of an application (block 602). The client device generates an index based at least in part on information of the application (block 604). In some implementations, the index is based at least in part on an identifier of the application, a version of the application, a version of the UMD, and one or more features selected by the user corresponding to execution of the application. In some implementations, the client device concatenates this information. In other implementations, the client device performs a hash function or uses another algorithm using this information as input values to generate the index.

The client device searches a driver characteristics table using the index (block 606). If the client device does not find an entry in the driver characteristics table (or table) based on the index (“no” branch of the conditional block 608), then the client device selects a user mode driver (UMD) of a most-recently staged graphics driver package (block 610). Afterward, the client device executes the process using installations of the selected UMD and the kernel mode driver (KMD) of the most-recently staged graphics driver package (block 618).

If the client device finds an entry in the driver characteristics table based on the index (“yes” branch of the conditional block 608), then the client device retrieves one or more counts of events from the entry (block 612). The events occur during the execution of a particular version of the application. The execution is also based on a version of the UMD and features selected by the user. The counts of events include a number (or count) of launches of the application during execution, a number (or count) of timeout detection and recovery (TDR) events of the application during execution, and a number (or count) of crashes of the application during execution. In other implementations, another number and types of events based on execution of the application are used.

The client device compares the counts with corresponding thresholds. The client device generates a weighted sum based on the comparisons and compares the weighted sum to a corresponding threshold. The comparisons are used to determine whether the version of the user mode driver stored in the hit table entry should be used for a subsequent execution of the particular version of the application. For example, if the comparisons indicate high performance of the particular version of the application using the particular version of the UMD, then the same version of the UMD should be used. If the counts do not indicate high performance (“no” branch of the conditional block 614), then control flow of method 600 moves to block 610 where the client device selects the UMD of the most-recently staged graphics driver package. If the counts indicate high performance (“yes” branch of the conditional block 614), then the client device selects a version of a user mode driver (UMD) stored in the entry (block 616). Afterward, the client device executes the process using installations of the selected UMD and the kernel mode driver (KMD) of the given graphics driver package (block 618).

Turning now to FIG. 7, a generalized diagram is shown of a method 700 that provides stability when updated graphics drivers are used in different hardware configurations. The circuitry of a client device includes one or more of a parallel data processor, another processor, or other circuitry. The circuitry of the client device executes a process of an application using installations of a selected user mode driver (UMD) of multiple available UMDs and a kernel mode driver (KMD) of the most-recently staged graphics driver package (block 702). The client device monitors performance characteristics as the process executes (block 704). The characteristics include a number of events occurring during execution of the application that can differ among other different hardware configurations. Examples of the events are launches of the application, crashes of the application, and timeout detection and recovery (TDR) events. The client device updates a driver characteristics table based on the performance characteristics (block 706).

To update the driver characteristics table (or table), the client device generates an index to search the table to identify a table entry to update. In some implementations, the index is based at least in part on an identifier of the application, a version of the application, a version of the UMD, and one or more features selected by the user corresponding to execution of the application. In some implementations, the client device concatenates this information. In other implementations, the client device performs a hash function or uses another algorithm using this information as input values to generate the index. The selected table entry has one or more fields updated based on events that occur during the execution of the application.

In some implementations, client device executes program code for collecting and submitting telemetry data to a centralized location. The centralized location can be a site for the vendor that produced the particular application. The telemetry data can be submitted based on preset events or schedules. In various implementations, the telemetry data includes at least a copy of the table, and additionally, the telemetry data can include an indication of the hardware configuration of the client device.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVER, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. A processor comprising:
circuitry configured to:
receive a process of a first application;
select a first user mode driver of a previously staged graphics driver package different from a most-recently staged graphics driver package; and
execute the process of the first application using the first user mode driver to translate instructions of the first application to commands.

2. The processor as recited in claim 1, wherein the circuitry is further configured to execute the process of the first application using a kernel mode driver of the most-recently staged graphics driver package.

3. The processor as recited in claim 1, wherein, while executing the process of the first application, the circuitry is further configured to update performance characteristics associated with the first application and the first user mode driver.

4. The processor as recited in claim 3, wherein the circuitry is further configured to select the first user mode driver based further in part on one or more of the performance characteristics.

5. The processor as recited in claim 3, wherein the performance characteristics comprise at least a number of crashes of the first application.

6. The processor as recited in claim 3, wherein the circuitry is further configured to store a copy of one or more user mode drivers of previously staged graphics driver packages in protected holding locations in a memory.

7. The processor as recited in claim 3, wherein the circuitry is further configured to:
receive a process of a second application;
select a second user mode driver of the most-recently staged graphics driver package based at least in part on one or more of performance characteristics associated with the second application and the second user mode driver; and
execute the process of the second application using the second user mode driver to translate instructions of the second application to commands.

8. A method comprising:
receiving, by circuitry of a first processor, a process of a first application;
selecting, by the circuitry, a first user mode driver of a previously staged graphics driver package different from a most-recently staged graphics driver package; and
executing, by the circuitry, the process of the first application using the first user mode driver to translate instructions of the first application to commands executable by a second processor different from the first processor.

9. The method as recited in claim 8, further comprising executing, by the circuitry, the process of the first application using a kernel mode driver of the most-recently staged graphics driver package.

10. The method as recited in claim 8, wherein, while executing the process of the first application, the method further comprises updating, by the circuitry, performance characteristics associated with the first application and the first user mode driver.

11. The method as recited in claim 10, further comprising selecting, by the circuitry, the first user mode driver based further in part on one or more of the performance characteristics.

12. The method as recited in claim 10, wherein the performance characteristics comprise at least a number of launches of the first application.

13. The method as recited in claim 10, further comprising storing, by the circuitry, a copy of one or more user mode drivers of previously staged graphics driver packages to protected holding locations in a memory.

14. The method as recited in claim 10, further comprising:
receiving, by the circuitry, a process of a second application;
selecting, by the circuitry, a second user mode driver of the most-recently staged graphics driver package based at least in part on one or more of performance characteristics associated with the second application and the second user mode driver; and
executing, by the circuitry, the process of the second application using the second user mode driver to translate instructions of the second application to commands executable by the second processor.

15. A computing system comprising:
a first processor configured to execute applications; and
a second processor configured to execute applications; and
wherein circuitry of the first processor is configured to:
receive a process of a first application;
select a first user mode driver of a previously staged graphics driver package different from a most-recently staged graphics driver package; and
execute the process of the first application using the first user mode driver to translate instructions to commands executable by the second processor.

16. The computing system as recited in claim 15, wherein the circuitry is further configured to execute the process of the first application using a kernel mode driver of the most-recently staged graphics driver package.

17. The computing system as recited in claim 15, wherein, while executing the process of the first application, the circuitry is further configured to update performance characteristics associated with the first application and the first user mode driver.

18. The computing system as recited in claim 17, wherein the circuitry is further configured to select the first user mode driver based further in part on one or more of the performance characteristics.

19. The computing system as recited in claim 17, wherein the performance characteristics comprise at least a number of timeout detection and recovery (TDR) events of the first application.

20. The computing system as recited in claim 17, wherein the circuitry is further configured to store a copy of one or more user mode drivers of previously staged graphics driver packages to protected holding locations in a memory.
